(19) United States
(12) Patent Application Publication
(10) Pub. No.: US 2015/0186157 A1
(43) Pub. Date: Jul. 2, 2015

(54) TECHNIQUES FOR WORKLOAD SCALABILITY-BASED PROCESSOR PERFORMANCE STATE CONTROL

(71) Applicants: Guy M. Therien, Beaverton, OR (US); Venkatesh Ramani, Milpitas, CA (US)

(72) Inventors: Guy M. Therien, Beaverton, OR (US); Venkatesh Ramani, Milpitas, CA (US)

(21) Appl. No.: 14/142,757

(22) Filed: Dec. 28, 2013

(51) Int. Cl. G06F 9/445

(52) U.S. Cl. CPC G06F 9/44505

(57) ABSTRACT

Methods and apparatus relating to workload scalability-based processor performance state control are described. In an embodiment, logic detects a request to change a performance setting for a processor. The logic causes modification to the request based on workload scalability information that is detected by hardware in the processor. The workload scalability information is detected over a (e.g., an observation) period. Other embodiments are also disclosed and claimed.

### FIELD

The present disclosure generally relates to the field of electronics. More particularly, an embodiment relates to techniques for workload scalability-based processor performance state control.

### BACKGROUND

To control power consumption, some processors are capable of operating at several different frequencies. For example, if a system is to reduce its power consumption (e.g., during idle times), a processor may be operated at a lower frequency. Alternatively, to improve performance (e.g., during complex computations), the processor may be operated at a higher frequency.

However, as processor design becomes more complex (e.g., to perform additional functionality), the task of changing power consumption settings becomes more complex and may require performance of various additional operations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 11-13 illustrate block diagrams of embodiments of computing systems, which may be utilized to implement various embodiments discussed herein.

FIG. 2 illustrates a block diagram of a system architecture to support Collaborative Processor Performance Control, according to an embodiment.

FIG. 3 illustrates a block diagram of a distributed control system to implement Collaborative Processor Performance Control, according to an embodiment.

FIGS. 4A-6B illustrates static and dynamic settings that may be used in various embodiments.

FIG. 7 illustrates a scalability thresholds map, according to an embodiment.

FIG. 8 illustrates a state machine, according to an embodiment.

FIGS. 9A and 9B illustrate state machine and scalability maps, according to some embodiments.

FIGS. 10A-10C illustrate flow diagrams to implement Collaborative Processor Performance Control according to some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

Some embodiments provide techniques for workload scalability-based processor performance state control. For example, some implementations may utilize a hardware-based workload scalability indicator provided in processor silicon to control processor core voltage and/or frequency, e.g., for a PCU (Power Control Unit) to reduce frequency from maximum turbo when a memory stall is detected. The various performance states may be referred to as EE P-states (where “EE” stands for Energy Efficient and “P-state” refers to performance state). When the scalability indicator is utilized by the PCU to make decisions, these decisions and control changes happen at a fine granularity (e.g., at about 1 ms). In some implementations, logic (such as a software driver) may be used that reads the scalability calculated by the hardware at a much slower rate (as mandated by software or OS (Operating System) control) and based on the scalability values control processor P-states to achieve significant power savings with little or no observable performance or quality impact. To this end, an embodiment provides an optimal control mechanism (i.e., maximum energy benefit and/or minimum performance loss) for driver or OS based utilization of a hardware-based scalability indicator for P-state control. If processor core frequency is reduced merely based on Processor core scalability indicator, significant performance loss may occur in Graphics and other sub-systems for workloads targeting those sub-systems (e.g., Graphics 3D games). To minimize performance loss/quality impact for such workloads, some implementations may utilize hardware indicators such as Graphics Busyness/Scalability indicator in addition to the Processor core scalability indicator while selecting an appropriate processor core EE P-state.

In one embodiment, logic (such as a software driver, which may provide CPPC or Collaborative Processor Performance Control) receives/detects requests (e.g., originating from OS or a software application) for processor performance settings and alters the requests to attain energy efficiency. For example, OS requests for turbo range P-states are compared against the historical scalability as determined by hardware (e.g., read via an MSR (Model Specific Register) or more generally a control register) and below a certain scalability threshold a lower frequency and/or voltage is chosen than what is requested by the OS. Hence, even though some embodiments discussed herein utilize frequency to modify processor performance settings, voltage level changes may also be utilized to modify processor performance settings. Further, the timescales of OS-based P-state control using a scalability indicator may be much greater than the fine grain control available on-chip in the EE P-states implementation. As such, reading scalability over an observation period, setting P-state, and re-evaluation to determine the need for additional action is achieved in accordance with some embodiments.

As discussed herein, a “turbo” mode generally refers to an operation mode that allows a processor to increase the supply voltage and/or frequency up to a pre-defined Thermal Design Power (TDP) limit for a period of time, for example, due to workload demands. Also, P-states discussed herein generally refer to processor performance states achieved at least in part based on OS or software application input. In some embodiments, at least some of the processor performance states discussed herein may be in accordance with or similar to those defined under Advanced Configuration and Power Interface (ACPI) specification, Revision 5, December 2011.

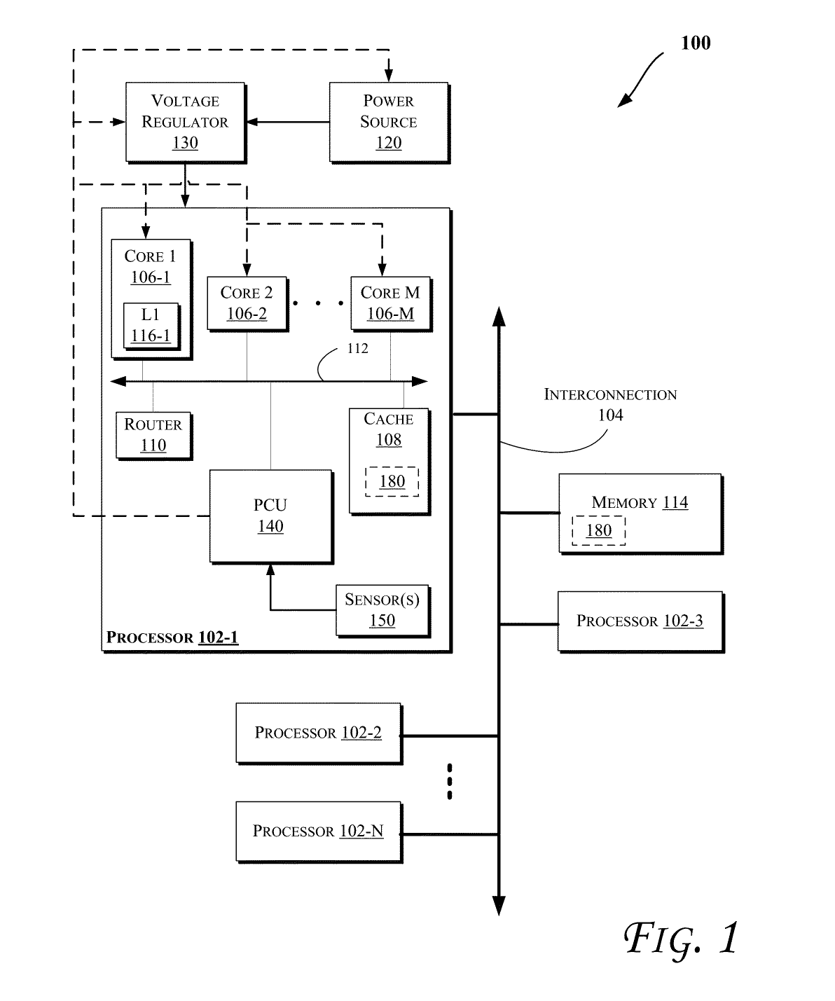

Some embodiments may be applied in computing systems that include one or more processors (e.g., with one or more processor cores), such as those discussed with reference to FIGS. 1-13, including for example mobile computing devices such as a smartphone, tablet, UMPC (Ultra-Mobile Personal Computer), laptop computer, Ultrabook™ computing device, smart watch, smart glasses, wearable devices, etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may be general-purpose CPUs and/or GPUs in various embodiments. The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

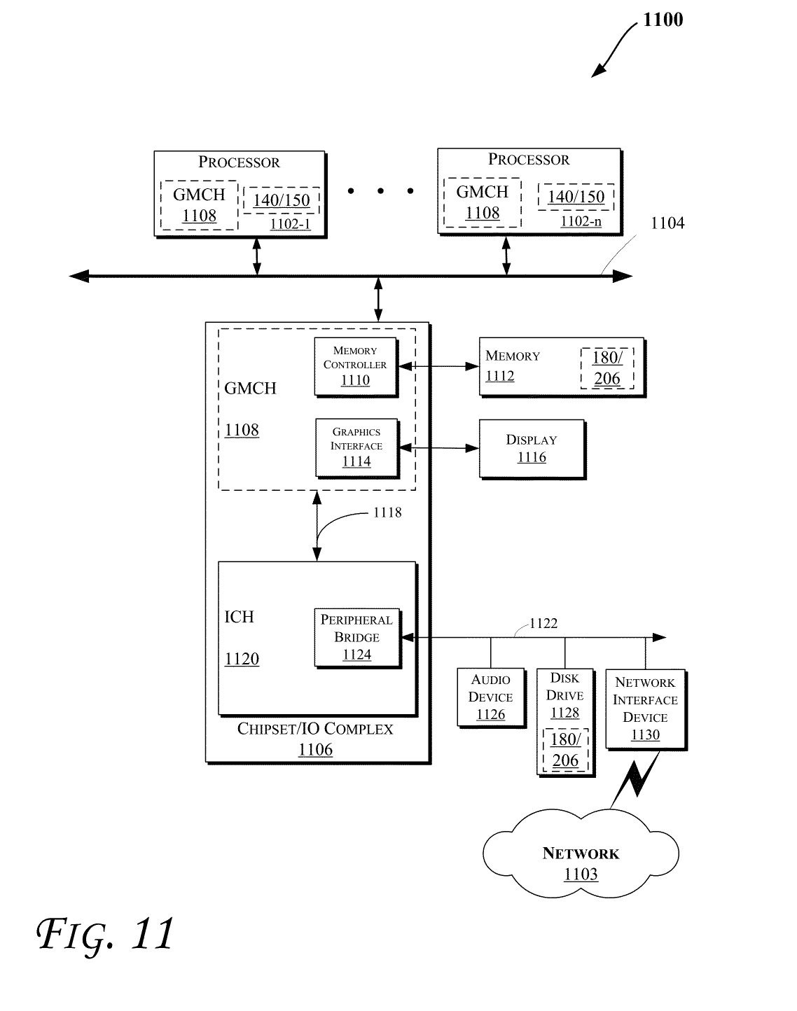

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 11-13), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a power source 120 (e.g., a direct current (DC) power source or an alternating current (AC) power source) to provide power to one or more components of the system 100. In some embodiments, the power source 120 may include one or more battery packs and/or power supplies. The power source 120 may be coupled to components of system 100 through a voltage regulator (VR) 130 (which may be a single or multiple phase VR). In an embodiment, the VR 130 may be a FIVR (Fully Integrated Voltage Regulator). Moreover, even though FIG. 1 illustrates one power source 120 and one voltage regulator 130, additional power sources and/or voltage regulators may be utilized. For example, each of the processors 102 may have corresponding voltage regulator(s) and/or power source(s). Also, the voltage regulator(s) 130 may be coupled to the processor 102 via a single power plane (e.g., supplying power to all the cores 106) or multiple power planes (e.g., where each power plane may supply power to a different core or group of cores). Power source may be capable of driving variable voltage or have different power drive configurations.

Additionally, while FIG. 1 illustrates the power source 120 and the voltage regulator 130 as separate components, the power source 120 and the voltage regulator 130 may be integrated and/or incorporated into other components of system 100. For example, all or portions of the VR 130 may be incorporated into the power source 120 and/or processor 102. Furthermore, as shown in FIG. 1, the power source 120 and/or the voltage regulator 130 may communicate with the power control logic 140 and report their power specification.

As shown in FIG. 1, the processor 102 may further include PCU logic 140 to control supply of power to one or more components of the processor 102 (e.g., cores 106). Logic 140 may have access to one or more storage devices discussed herein (such as cache 108, L1 cache 116, memory 114, register(s), or another memory in system 100) to store information relating to operations of the PCU logic 140 such as information communicated with various components of system 100 as discussed here.

As shown, the logic 140 may be coupled to the VR 130 and/or other components of system 100 such as the cores 106 and/or the power source 120. For example, the PCU logic 140 may be coupled to receive information (e.g., in the form of one or more bits or signals) to indicate status of one or more sensors 150 (where the sensor(s) 150 may be located proximate to components of system 100 (or other computing systems discussed herein such as those discussed with reference to other figures including FIGS. 11-13, for example), such as the cores 106, interconnections 104 or 112, etc. Sensors 150 sense variations in various factors affecting power/thermal behavior of the system, such as temperature, operating frequency, operating voltage, operating current, dynamic capacitance, power consumption, inter-core communication activity, workload scalability indicators, etc.). The PCU 140 (or other logic such a software driver 180 stored in memory 114 and/or cache 108) may then modify requests received from the OS or software based on information detected by the sensors 150 (e.g., regarding workload stability indications) to achieve processor performance state control.

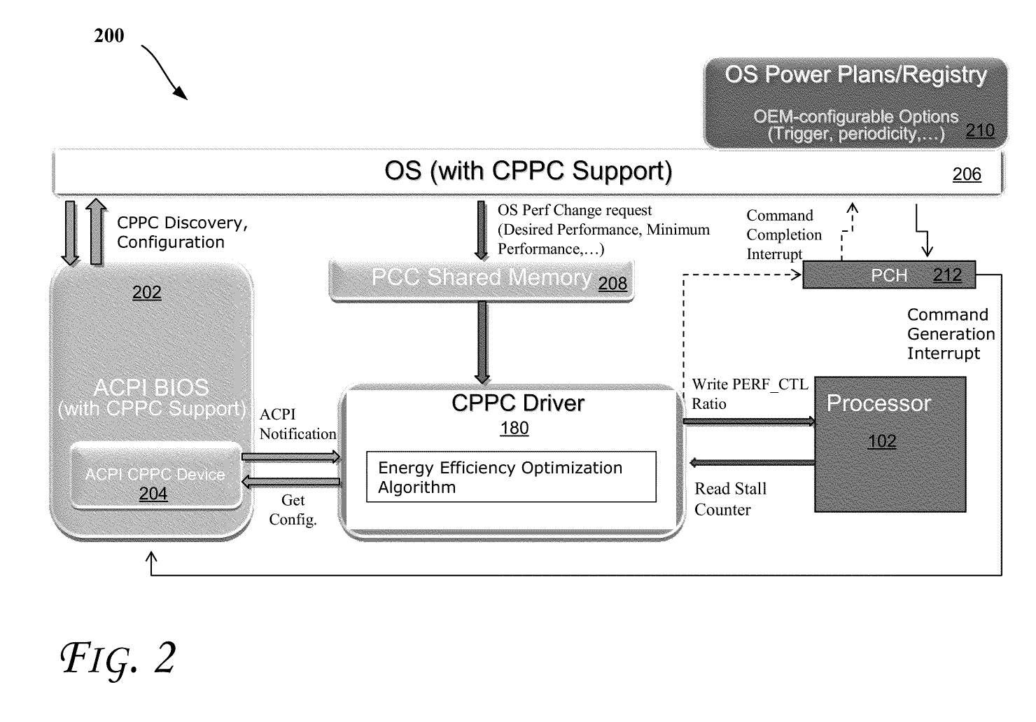

For example, the sensor(s) 150 may detect whether one or more subsystems are active and/or their workload scalability indicator information (e.g., as discussed with reference to FIGS. 2-10C). Logic 140 (e.g., at the direction of the software driver 180) may in turn instruct the VR 130, power source 120, and/or individual components of system 100 (such as the cores 106) to modify their operations or performance state. For example, logic 140 may indicate to the VR 130 and/or power source 120 to adjust their output. In some embodiments, logic 140 may request the cores 106 to modify their operating frequency, power consumption, dynamic capacitance, operating current, etc. Also, even though components 140 and 150 are shown to be included in processor 102-1, these components may be provided elsewhere in the system 100. For example, power control logic 140 may be provided in the VR 130, in the power source 120, directly coupled to the interconnection 104, within one or more (or alternatively all) of the processors 102, etc. Also, even though cores 106 are shown to be processor cores, these can be other computational element such as graphics cores, special function devices, etc.

FIG. 2 illustrates a block diagram of a system 200 providing an architecture to support CPPC, according to an embodiment. As shown, system 200 includes an ACPI BIOS (Basic Input Output System) storage device 202 (having CPPC support, e.g., through provision of an ACPI CPPC device 204 which communicates with the CPPC driver 180 to provide ACPI notification and obtaining configuration information). As discussed herein, driver 180 may provision an algorithm to provide energy efficiency optimization (e.g., via PCU 140 and based on information regarding scalability indicators).

System 200 also includes an OS 206 with CPPC support to communicate CPPC discovery/configuration with BIOS 202 and communicate performance change requests (regarding desired performance, minimum performance, etc.) with the driver 180 through a PCC (Platform Communications Channel) shared memory 208. OS 206 may also have access to stored information 210 (e.g., in one or more registers or other types of memory/storage such as those discussed herein) regarding power plans or registry (e.g., that includes OEM (Original Equipment Manufacturer) configurable options (such as a trigger, periodicity, etc.). Also, as shown in FIG. 2, processor 102 may communicate with the driver 180 to receive write performance control ratio values/settings information and provide stall counter data (e.g., indicating detection of a memory stall, etc.). System 200 also includes a Platform Control Hub (PCH) to communicate with various components of system 200, such as command generation interrupt with ACPI BIOS (e.g., OS writes a new “Perf” (or “performance” as used herein interchangeably) Change command in PCC shared memory and writes a door-bell register in PCH that generates an interrupt to communicate a new Perf Change command to the platform. ACPI BIOS services the interrupts and notifies CPPC driver for further processing of the OS command) and (optionally) for the ACPI BIOS/CPPC driver to generate a command completion interrupt to the OS 180 (e.g., after the CPPC driver has processed a Perf Change command from the OS, it writes to a PCH register that generates an interrupt to the OS to indicate command completion).

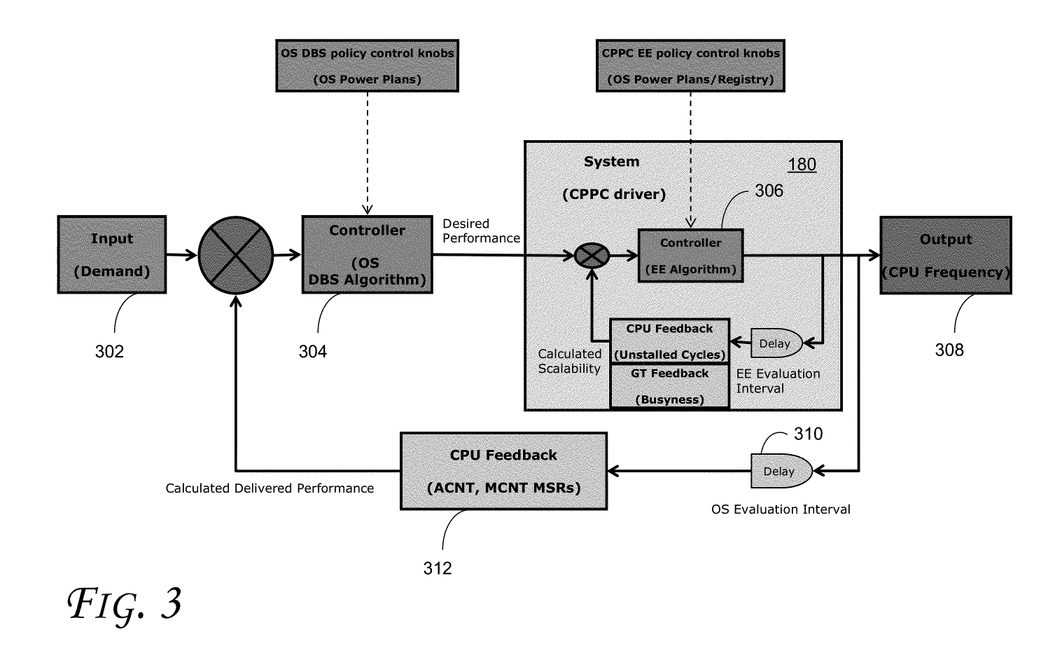

FIG. 3 illustrates a block diagram of a distributed control system to implement CPPC, according to an embodiment. In one embodiment, the illustrated system of FIG. 3 may be used to provide a software architecture to provide CPPC. As shown, input (regarding demand) is received at block 302 and passed to controller logic 304 (which implements the OS DBS (Demand-Based Selection) algorithm based on input from OS DBS policy control knobs (or OS power plans 210)). As discussed herein, a “knob” generally refers to a configuration setting/value. The controller 304 generates the desired performance request and passes it to the system (e.g., CPPC driver 180). Driver 180 includes a controller logic 306 to perform EE algorithm based at least in part on CPPC EE policy control knobs (e.g., per OS power plans/registry 210). Controller 306 utilizes a feedback loop including a delay block to provide the EE evaluation interval as well as CPU/processor feedback (e.g., regarding the number of un-stalled, un-halted cycles of the processor 102) and GT (Graphics Technology)) feedback (e.g., regarding busyness of the GT processor 102) to calculate scalability of processor 102.

The output of the driver 180 is provided at block 308 (e.g., in terms of CPU/processor frequency, such as discussed with reference to the PCU 140 of FIG. 1). A further feedback loop is also provided with delay block 310 to provide an OS evaluation interval as well as a CPU feedback at block 312 (e.g., with ACNT (Actual Performance Frequency Clock Count), MCNT (Maximum Performance Frequency Clock Count) MSRs) to provide the calculated delivered performance back to controller logic 304.

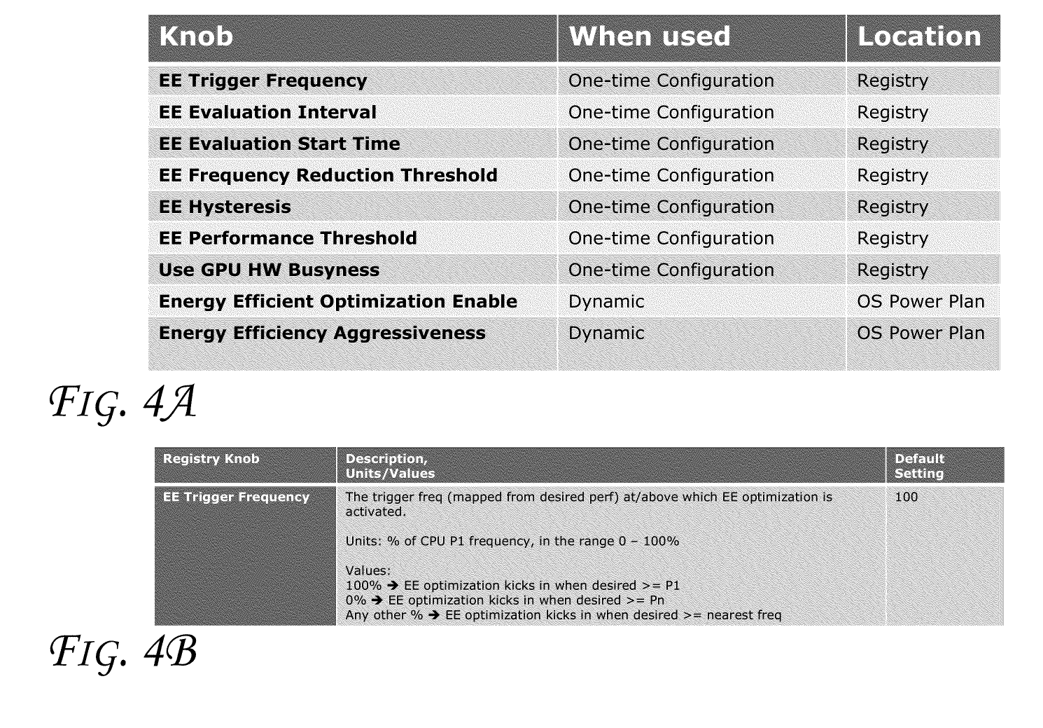

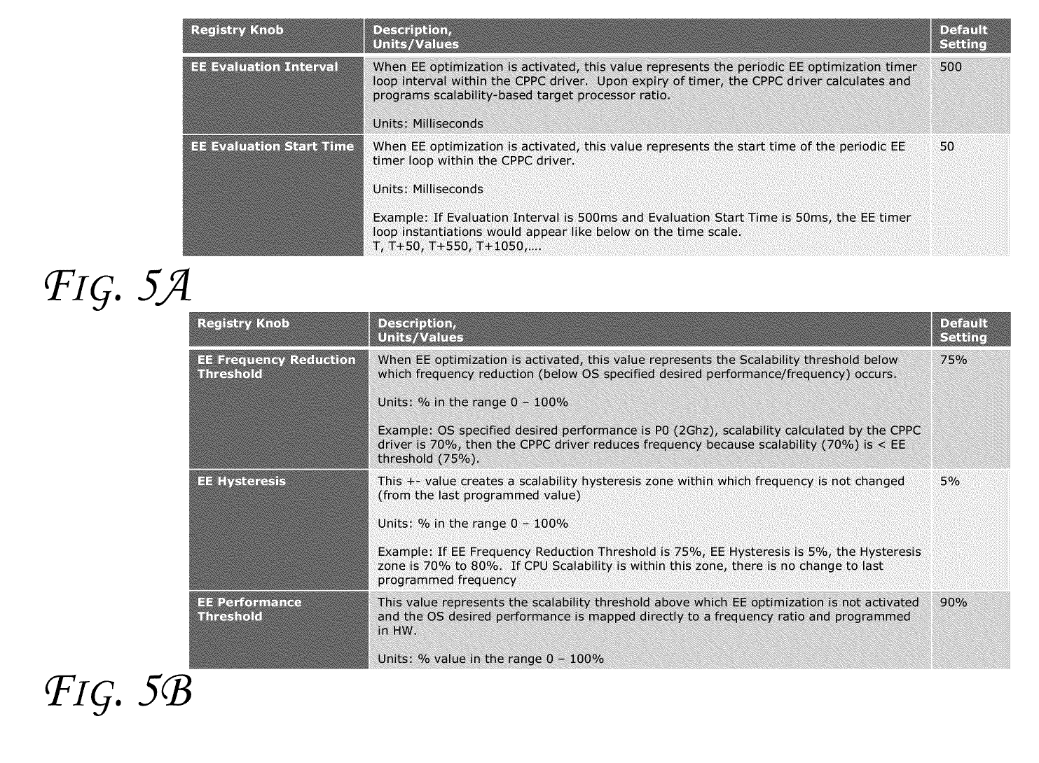

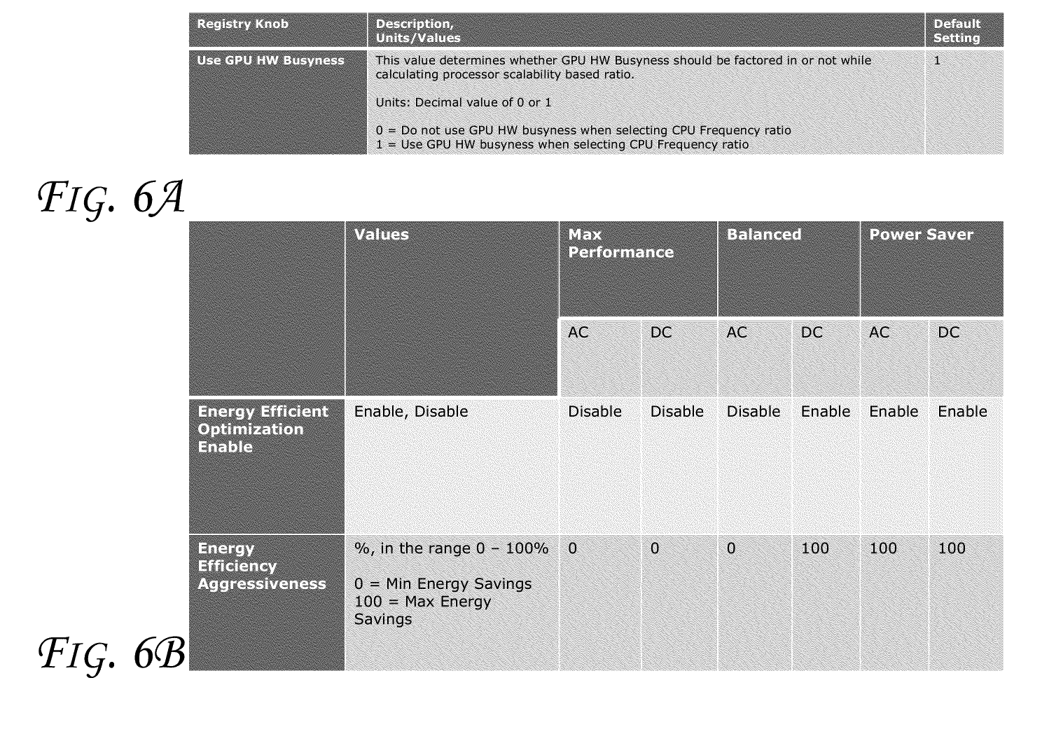

FIG. 4A illustrates CPPC EE policy control knobs that may be used in various embodiments. More particularly, two knob categories may be used: first, static, registry, one-time configuration knobs; second, dynamic, per OS power plan/source knobs. “HW” refers to hardware and GPU refers to Graphics Processing Unit in the figures. FIG. 4B illustrates a static CPPC registry knob, according to an embodiment. The illustrated knob may be used for EE optimization frequency trigger (which may or may not be exposed in registry). Also, a default setting may be stored for CPPC driver 180. FIG. 5A illustrates static CPPC registry knobs, according to an embodiment. The illustrated knobs may be used for EE optimization timer controls. FIG. 5B illustrates static CPPC registry knobs, according to an embodiment. The illustrated knobs may be used for EE optimization scalability threshold values. FIG. 6A illustrates a static CPPC registry knob, according to an embodiment. The illustrated knob may be used for GPU sensitivity. FIG. 6B illustrates dynamic CPPC power plan knobs, according to an embodiment. The illustrated knobs may be used for EE optimization enable and/or aggressiveness.

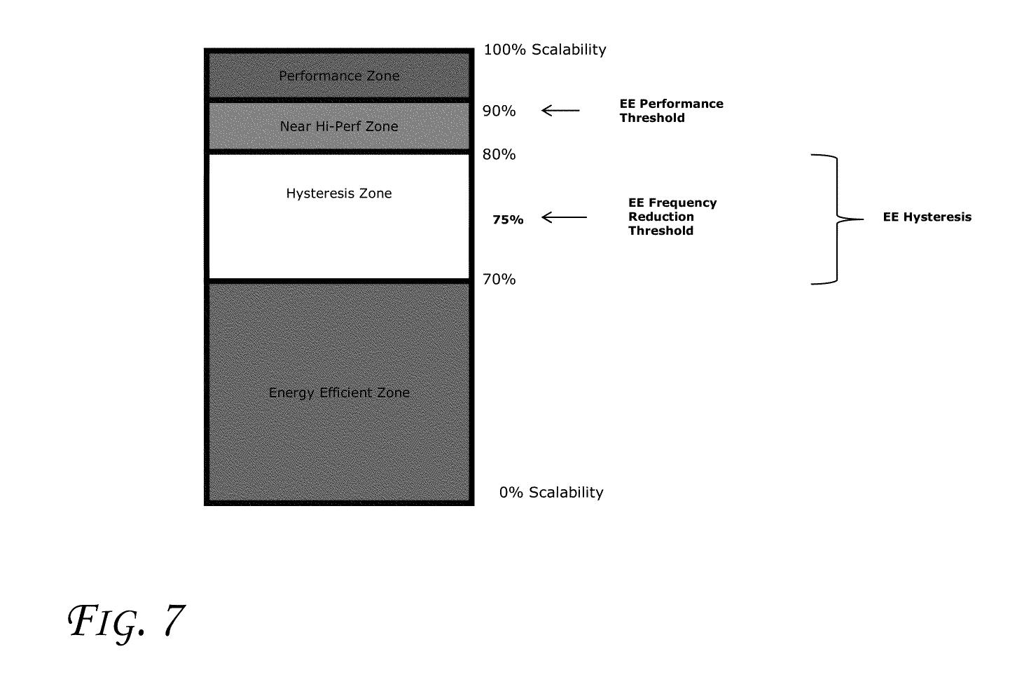

FIG. 7 illustrates a scalability thresholds map, according to an embodiment. As shown, multiple zones of performance may be used with various configurable threshold values for EE performance, and EE frequency reduction.

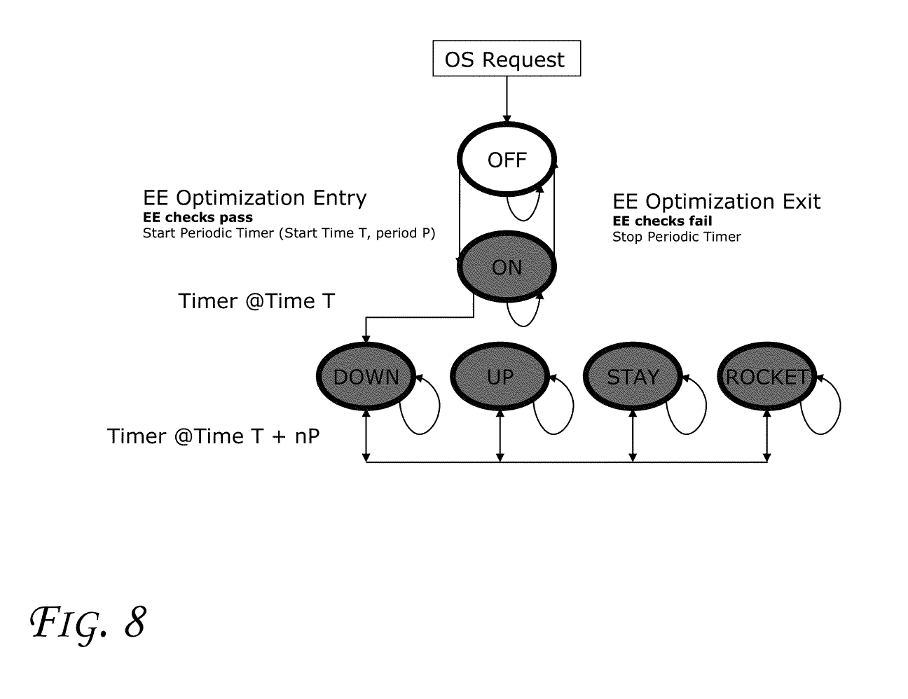

FIG. 8 illustrates a CPPC EE state machine, according to an embodiment. There are six states including: OFF (OS desired P-state), ON, STAY (no change to current P-state), UP (increase current P-state frequency by one step, DOWN (scalability-based P-state), and ROCKET (OS desired P-state). In an embodiment, any EE trigger change resets state machine (e.g., to OFF state). As shown, upon receipt of an OS request, the state machine goes to OFF state first. After EE optimization entry (EE checks pass and starts period timer with star time T and period P) and goes to state ON. Once the timer reaches time T, various states may be entered (such as DOWN, UP, STAY, or ROCKET). Upon exit from EE optimization (e.g., EE checks fail thereby causing an ON->OFF state transition), periodic timer is stopped.

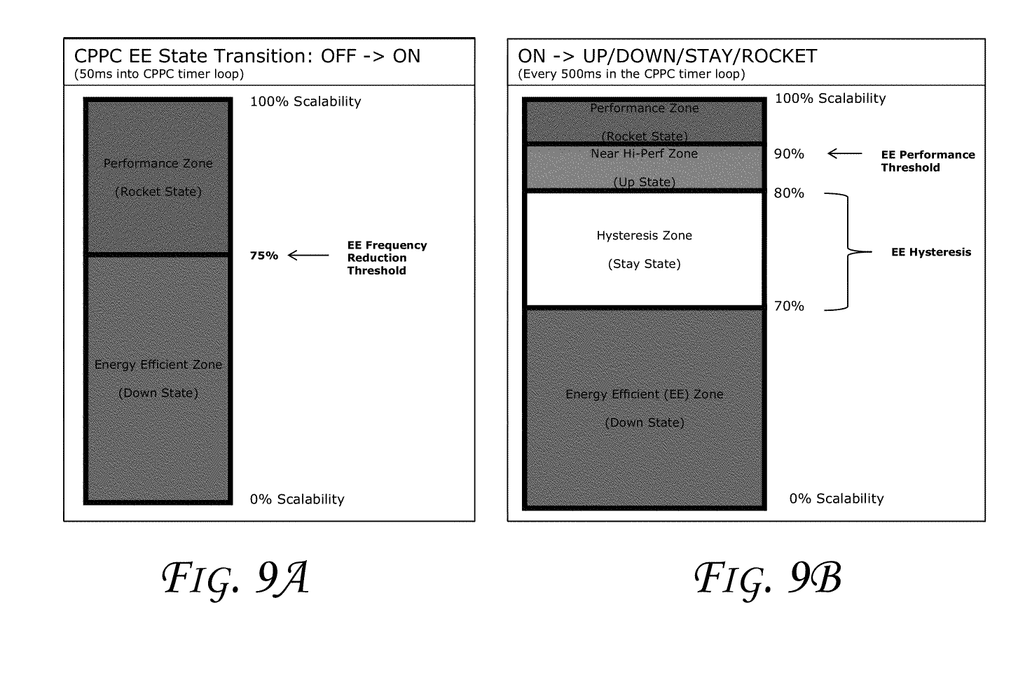

FIGS. 9A and 9B illustrate EE state machine and scalability maps for CPPC, according to some embodiments. More particularly, FIG. 9A shows a CPPC EE state transition map from OFF state to ON state. FIG. 9B shows the map for transmission from ON state to one of UP/DOWN/STAY/ROCKET states.

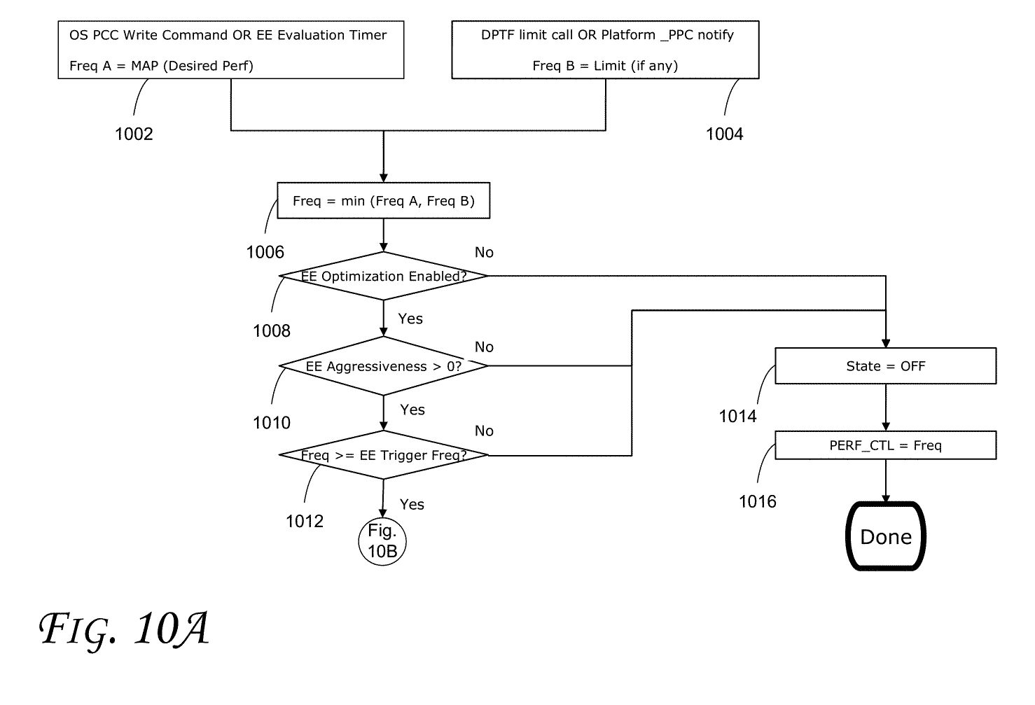

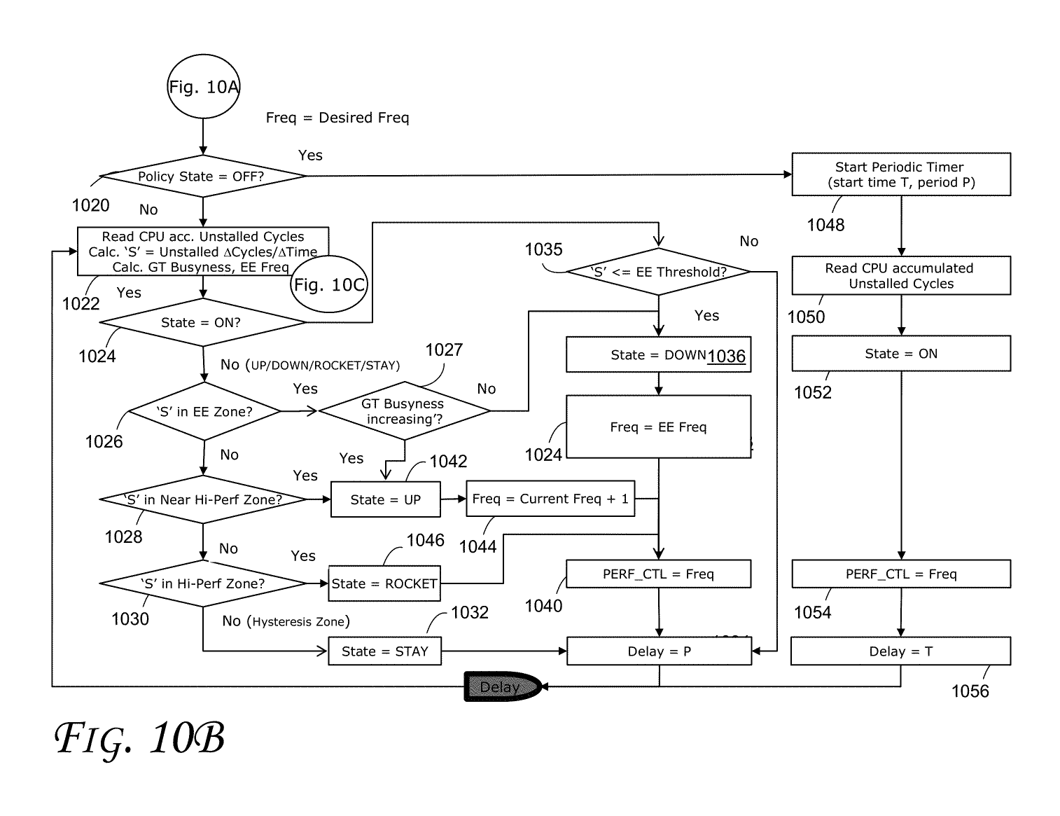

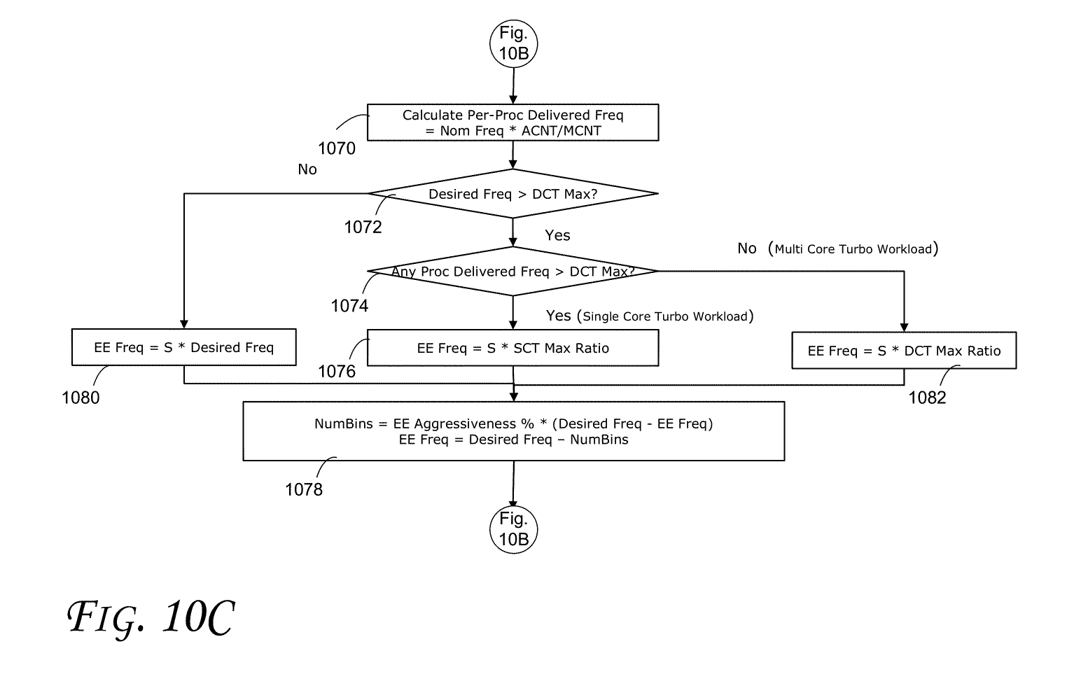

FIGS. 10A-10C illustrate flow diagrams for EE algorithm to implement CPPC, according to some embodiments. One or more components discussed herein (e.g., with reference to FIGS. 1-9B and 11-13) may be used to perform one or more operations discussed with reference to FIGS. 10A-10C. More particularly, FIG. 10A shows EE trigger checks. FIG. 10B shows operations for scalability and application of EE frequency. FIG. 10C shows operations to calculate EE frequency (where EE frequency is a function of the desired P-state frequency, delivered frequency, scalability, workload type, and/or EE aggressiveness).

Referring to FIGS. 10A-10C, at an operation 1002, OS PCC (Platform Communications Channel) write command or EE evaluation timer expiration are detected and frequency A is mapped from the OS-specified desired performance setting. At operation 1004, frequency B is set to the most constraining P-State limits from DPTF (Intel® Corporation's Dynamic Performance and Thermal Framework software) and platform ACPI_PPC (Performance Present Capabilities) P-state limit. At an operation 1006, frequency value is set to minimum of frequencies A and B. If EE optimization is enabled at operation 1008, operation 1110 determines whether EE aggressiveness is larger than zero. If EE aggressiveness is larger than zero, an operation 1012 determines whether the frequency value is larger or equal to EE trigger frequency threshold value. Operation 1014 is performed to set the state to OFF if operations 1008-1012 are returned with a negative response. Operation 1016 programs the processor's performance control register to the frequency value.

If the frequency value is less than the EE trigger frequency at operation 1012, the method continues with the flow of FIG. 10B at operation 1020. If policy state is not in OFF state (as determined at operation 1020), operation 1022 reads the CPU/processor accumulated un-stalled, un-halted cycles and hardware scalability value “S” is calculated as the un-stalled, un-halted delta of cycles over delta of time. Also, EE frequency is calculated per the flow of FIG. 10C, starting at operation 1070. At operation 1024 if the state is not ON, operation 1026 determines whether “S” is EE zone. If “S” is outside of the EE zone, operation 1028 determines whether “S” is near the high performance zone and if not operation 1030 determines whether “S” is in high performance zone. If “S” is not in high performance zone, state is set to STAY at operation 1032 and operation 1034 sets the delay to “P”. After the delay, the flow returns to operation 1022.

At operation 1024, if the state is ON, operation 1035 is followed by operation 1036 (to set the state to down) if “S” is determined to be less than or equal to EE threshold value at operation 1035. If operation 1035 determines that “S” is less than the EE threshold value, the method resumes at operation 1034. Also, if “S” is in the EE zone (operation 1026), operation 1027 determines whether GT Busyness is increasing and if not operation 1036 is performed; otherwise, operation 1042 is performed. At operation 1038, the frequency value is set to EE frequency (followed by operation 1040 that sets the processor's performance control register value to the frequency value, which is then followed by operation 1034). After a positive determination at operation 1028, operation 1042 sets the state to UP and operation 1044 performs a single-step increase of the frequency value to a higher performance P-state. After a positive output from operation 1030, the state is set to ROCKET at operation 1046, and the method resumes at operation 1040.

If at operation 1020, it is determined that the state is OFF, operation 1048 starts a periodic timer with start time T and period P). At operation 1050, processor's accumulated un-stalled, un-halted cycles are read and state is set to ON at operation 1052. Operation 1054 sets the processor's performance control register to the frequency value and operation 1056 sets the delay value to T. After the delay period, the method resumes at operation 1022.

Referring to FIG. 10C, operation 1070 calculates per logical processor delivered frequency as the product of the processor core's nominal frequency and ACNT/MCNT (where ACNT is a logical processor's un-halted cycles at its operating frequency and MCNT is a logical processor's un-halted cycles at its nominal frequency). If at operation 1072, desired frequency is greater than the processor core's maximum DCT (Dual Core Turbo frequency limit), operation 1074 determines whether any logical processor's delivered frequency is greater than maximum DCT. Operation 1076 sets EE frequency to the product of S and maximum SCT (Single Core Turbo frequency limit). Operation 1078 sets the number of P-state frequency steps to the product of EE aggressive percentage and the difference of desired P-state frequency and EE frequency. Also, EE frequency is set to the difference between the desired P-state frequency and the number of P-state frequency steps.

Furthermore, if the desired P-state frequency is not greater than the maximum DCT frequency at operation 1072, operation 1080 sets the EE frequency to the product of “S” and the desired P-state frequency before resuming at operation 1078. Also, if the output of operation 1074 is negative, then operation 1082 sets the EE frequency to the product of “S” and maximum DCT frequency before resuming at operation 1078.

FIG. 11 illustrates a block diagram of a computing system 1100 in accordance with an embodiment. The computing system 1100 may include one or more central processing unit(s) (CPUs) 1102 or processors that communicate via an interconnection network (or bus) 1104. The processors 1102 may include a general purpose processor, a network processor (that processes data communicated over a computer network 1103), or other types of a processor (including a reduced instruction set computer (RISC) processor or a complex instruction set computer (CISC)).

Moreover, the processors 1102 may have a single or multiple core design. The processors 1102 with a multiple core design may integrate different types of processor cores on the same integrated circuit (IC) die. Also, the processors 1102 with a multiple core design may be implemented as symmetrical or asymmetrical multiprocessors. In an embodiment, one or more of the processors 1102 may be the same or similar to the processors 102 of FIG. 1. For example, one or more components of system 1100 may include one or more of logic 140, sensor(s) 150, and/or logic/driver 180 discussed with reference to FIGS. 1-10C. Also, the operations discussed with reference to FIGS. 1-10C may be performed by one or more components of the system 1100.

A chipset 1106 may also communicate with the interconnection network 1104. The chipset 1106 may include a graphics memory control hub (GMCH) 1108, which may be located in various components of system 1100 (such as those shown in FIG. 11). The GMCH 1108 may include a memory controller 1110 that communicates with a memory 1112 (which may be the same or similar to the memory 114 of FIG. 1). The memory 1112 may store data, including sequences of instructions, that may be executed by the CPU 1102, or any other device included in the computing system 1100. In one embodiment, the memory 1112 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 1104, such as multiple CPUs and/or multiple system memories.

The GMCH 1108 may also include a graphics interface 1114 that communicates with a display device 1116. In one embodiment, the graphics interface 1114 may communicate with the display device 1116 via an accelerated graphics port (AGP) or Peripheral Component Interconnect (PCI) (or PCI express (PCIe) interface). In an embodiment, the display 1116 (such as a flat panel display) may communicate with the graphics interface 1114 through, for example, a signal converter that translates a digital representation of an image stored in a storage device such as video memory or system memory into display signals that are interpreted and displayed by the display 1116. The display signals produced by the display device may pass through various control devices before being interpreted by and subsequently displayed on the display 1116.

A hub interface 1118 may allow the GMCH 1108 and an input/output control hub (ICH) 1120 to communicate. The ICH 1120 may provide an interface to I/O device(s) that communicate with the computing system 1100. The ICH 1120 may communicate with a bus 1122 through a peripheral bridge (or controller) 1124, such as a peripheral component interconnect (PCI) bridge, a universal serial bus (USB) controller, or other types of peripheral bridges or controllers. The bridge 1124 may provide a data path between the CPU 1102 and peripheral devices. Other types of topologies may be utilized. Also, multiple buses may communicate with the ICH 1120, e.g., through multiple bridges or controllers. Moreover, other peripherals in communication with the ICH 1120 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 1122 may communicate with an audio device 1126, one or more disk drive(s) 1128, and a network interface device 1130 (which is in communication with the computer network 1103). Other devices may communicate via the bus 1122. Also, various components (such as the network interface device 1130) may communicate with the GMCH 1108 in some embodiments. In addition, the processor 1102 and the GMCH 1108 may be combined to form a single chip. Furthermore, a graphics accelerator may be included within the GMCH 1108 in other embodiments.

Furthermore, the computing system 1100 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 1128), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

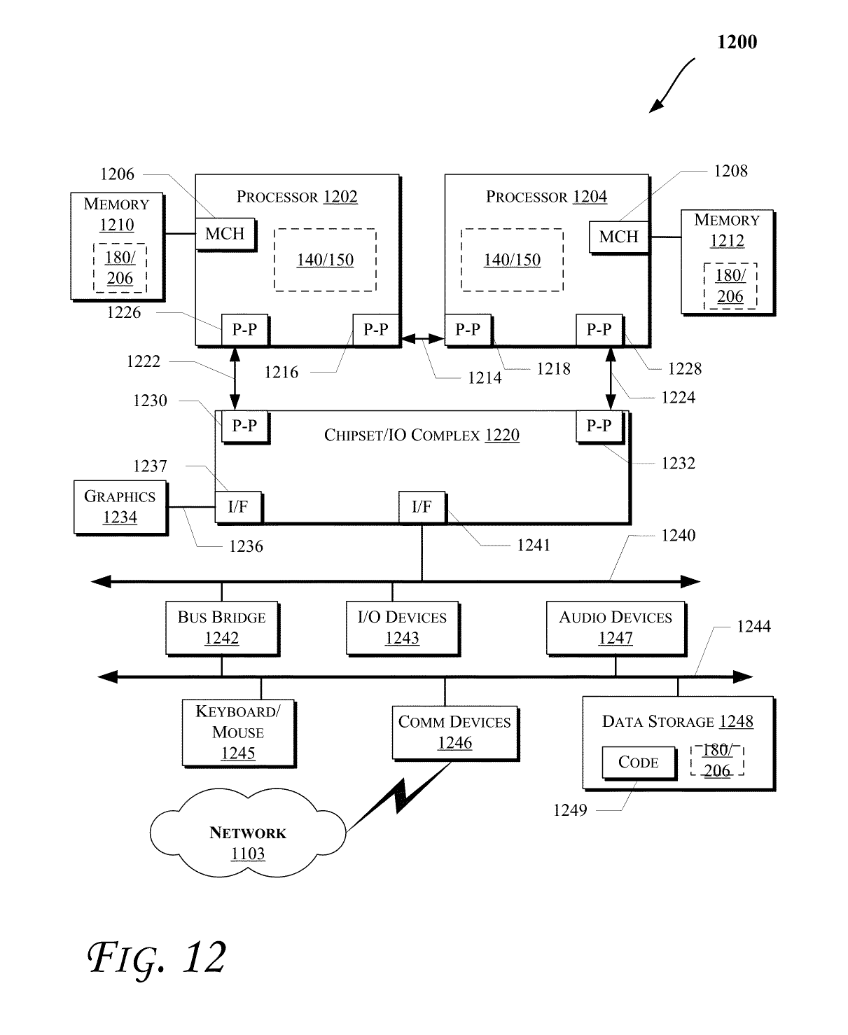

FIG. 12 illustrates a computing system 1200 that is arranged in a point-to-point (PtP) configuration, according to an embodiment. In particular, FIG. 12 shows a system where processors, memory, and input/output devices are interconnected by a number of point-to-point interfaces. The operations discussed with reference to FIGS. 1-11 may be performed by one or more components of the system 1200.

As illustrated in FIG. 12, the system 1200 may include several processors, of which only two, processors 1202 and 1204 are shown for clarity. The processors 1202 and 1204 may each include a local memory controller hub (MCH) 1206 and 1208 to enable communication with memories 1210 and 1212. The memories 1210 and/or 1212 may store various data such as those discussed with reference to the memory 1112 of FIG. 11.

In an embodiment, the processors 1202 and 1204 may be one of the processors 1102 discussed with reference to FIG. 11. The processors 1202 and 1204 may exchange data via a point-to-point (PtP) interface 1214 using PtP interface circuits 1216 and 1218, respectively. Also, the processors 1202 and 1204 may each exchange data with a chipset 1220 via individual PtP interfaces 1222 and 1224 using point-to-point interface circuits 1226, 1228, 1230, and 1232. The chipset 1220 may further exchange data with a graphics circuit 1234 via a graphics interface 1236, e.g., using a PtP interface circuit 1237.

At least one embodiment may be provided within the processors 1202 and 1204. For example, one or more components of system 1200 may include one or more of logic 140, sensor(s) 150, and/or logic/driver 180 of FIGS. 1-11, including located within the processors 1202 and 1204. Other embodiments, however, may exist in other circuits, logic units, or devices within the system 1200 of FIG. 12. Furthermore, other embodiments may be distributed throughout several circuits, logic units, or devices illustrated in FIG. 12.

The chipset 1220 may communicate with a bus 1240 using a PtP interface circuit 1241. The bus 1240 may communicate with one or more devices, such as a bus bridge 1242 and I/O devices 1243. Via a bus 1244, the bus bridge 1242 may communicate with other devices such as a keyboard/mouse 1245, communication devices 1246 (such as modems, network interface devices, or other communication devices that may communicate with the computer network 1103), audio I/O device 1247, and/or a data storage device 1248. The data storage device 1248 may store code 1249 that may be executed by the processors 1202 and/or 1204.

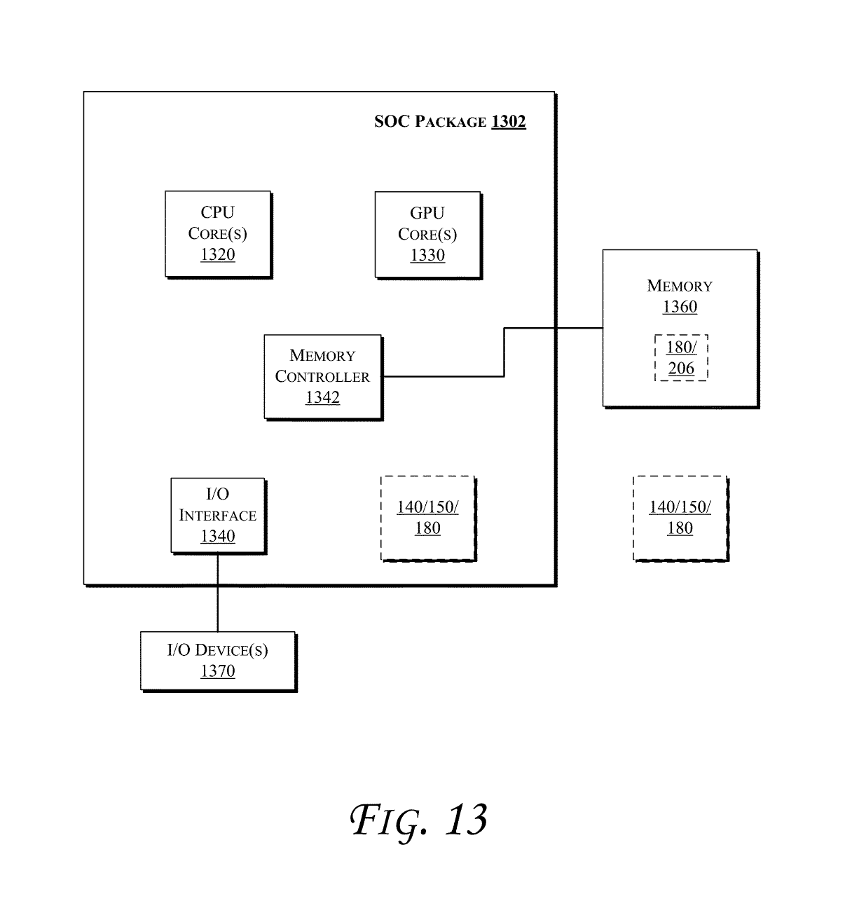

In some embodiments, one or more of the components discussed herein can be embodied as a System On Chip (SOC) device. FIG. 13 illustrates a block diagram of an SOC package in accordance with an embodiment. As illustrated in FIG. 13, SOC 1302 includes one or more Central Processing Unit (CPU) cores 1320, one or more Graphics Processor Unit (GPU) cores 1330, an Input/Output (I/O) interface 1340, and a memory controller 1342. Various components of the SOC package 1302 may be coupled to an interconnect or bus such as discussed herein with reference to the other figures. Also, the SOC package 1302 may include more or less components, such as those discussed herein with reference to the other figures. Further, each component of the SOC package 1320 may include one or more other components, e.g., as discussed with reference to the other figures herein. In one embodiment, SOC package 1302 (and its components) is provided on one or more Integrated Circuit (IC) die, e.g., which are packaged into a single semiconductor device.

As illustrated in FIG. 13, SOC package 1302 is coupled to a memory 1360 (which may be similar to or the same as memory discussed herein with reference to the other figures) via the memory controller 1342. In an embodiment, the memory 1360 (or a portion of it) can be integrated on the SOC package 1302.

The I/O interface 1340 may be coupled to one or more I/O devices 1370, e.g., via an interconnect and/or bus such as discussed herein with reference to other figures. I/O device(s) 1370 may include one or more of a keyboard, a mouse, a touchpad, a display, an image/video capture device (such as a camera or camcorder/video recorder), a touch screen, a speaker, or the like. Furthermore, SOC package 1302 may include/integrate the logic 140, sensor(s) 150, and/or logic/driver 180 in an embodiment. Alternatively, the logic 140, sensor(s) 150, and/or logic/driver 180 may be provided outside of the SOC package 1302 (i.e., as a discrete logic).

Moreover, the scenes, images, or frames discussed herein (e.g., which may be processed by the graphics logic in various embodiments) may be captured by an image capture device (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the frames in the scene are designed/generated on a computer in some embodiments. Also, one or more of the frames of the scene may be presented via a display (such as the display discussed with reference to FIGS. 11 and/or 12, including for example a flat panel display device, etc.).

The following examples pertain to further embodiments. Example 1 includes an apparatus comprising: logic, the logic at least partially comprising hardware logic, to detect a request to change a performance setting for a processor, wherein the logic is to cause modification to the request based on workload scalability information to be detected by hardware logic in the processor, wherein the workload scalability information is to be detected over a time period. Example 2 includes the apparatus of example 1, comprising logic to determine the workload scalability information based at least in part on a number of un-stalled, un-halted cycles of the processor or busyness of a graphics processing unit (GPU) or Graphics Technology (GT). Example 3 includes the apparatus of example 1, wherein the request is to be transmitted from an operating system or a software application. Example 4 includes the apparatus of example 3, further comprising memory to store the operating system or the software application. Example 5 includes the apparatus of example 1, wherein the workload scalability information is to be reevaluated after modification to the request. Example 6 includes the apparatus of example 1, further comprising memory to store the workload scalability information. Example 7 includes the apparatus of example 1, comprising logic to modify one or more of an operating frequency or an operating voltage of the processor in response to the request modification. Example 8 includes the apparatus of example 1, wherein the logic is to modify the request to provide an improved energy efficiency. Example 9 includes the apparatus of example 1, further comprising one or more sensors to detect variations, corresponding to components of the processor, in one or more of: temperature, operating frequency, operating voltage, operating current, dynamic capacitance, power consumption, inter-core communication activity, or the workload scalability information. Example 10 includes the apparatus of example 1, wherein the processor is to comprise one or more processor cores to perform graphics or general-purpose computational operations. Example 11 includes the apparatus of example 1, wherein one or more of the logic, a voltage regulator, or memory are on a single integrated circuit die.

Example 12 includes a method comprising: detecting a request to change a performance setting for a processor, wherein the logic is to cause modification to the request based on workload scalability information to be detected by hardware logic in the processor, wherein the workload scalability information is detected over a time period. Example 13 includes the method of example 12, further comprising determining the workload scalability information based at least in part on a number of un-stalled, un-halted cycles of the processor or busyness of a graphics processing unit (GPU) or Graphics Technology (GT). Example 14 includes the method of example 12, further comprising transmitting the request from an operating system or a software application. Example 15 includes the method of example 12, further comprising reevaluating the workload scalability information after modification to the request. Example 16 includes the method of example 12, further comprising causing modification one or more of an operating frequency or an operating voltage of the processor in response to the request modification. Example 17 includes the method of example 12, further comprising causing modification of the request to provide an improved energy efficiency. Example 18 includes the method of example 12, further comprising receiving signals from one or more sensors to detect variations, corresponding to components of the processor, in one or more of: temperature, operating frequency, operating voltage, operating current, dynamic capacitance, power consumption, inter-core communication activity, or the workload scalability information.

Example 19 includes a computer-readable medium comprising one or more instructions that when executed on a processor configure the processor to perform one or more operations to: detect a request to change a performance setting for the processor, wherein the logic is to cause modification to the request based on workload scalability information to be detected by hardware logic in the processor, wherein the workload scalability information is detected over a time period. Example 20 includes the computer-readable medium of example 19, further comprising one or more instructions that when executed on the processor configure the processor to perform one or more operations to determine the workload scalability information based at least in part on a number of un-stalled, un-halted cycles of the processor or busyness of a graphics processing unit (GPU) or Graphics Technology (GT). Example 21 includes the computer-readable medium of example 19, further comprising one or more instructions that when executed on the processor configure the processor to perform one or more operations to transmit the request from an operating system or a software application. Example 22 includes the computer-readable medium of example 19, further comprising one or more instructions that when executed on the processor configure the processor to perform one or more operations to reevaluate the workload scalability information after modification to the request. Example 23 includes the computer-readable medium of example 19, further comprising one or more instructions that when executed on the processor configure the processor to perform one or more operations to cause modification one or more of an operating frequency or an operating voltage of the processor in response to the request modification. Example 24 includes the computer-readable medium of example 19, further comprising one or more instructions that when executed on the processor configure the processor to perform one or more operations to cause modification of the request to provide an improved energy efficiency. Example 25 includes the computer-readable medium of example 19, further comprising one or more instructions that when executed on the processor configure the processor to perform one or more operations to receive signals from one or more sensors to detect variations, corresponding to components of the processor, in one or more of: temperature, operating frequency, operating voltage, operating current, dynamic capacitance, power consumption, inter-core communication activity, or the workload scalability information.

Example 26 includes a system comprising: a processor; a storage device to store performance settings for the processor; and logic, the logic at least partially comprising hardware logic, to detect a request to change the stored performance setting for the processor, wherein the logic is to cause modification to the request based on workload scalability information to be detected by hardware logic in the processor, wherein the workload scalability information is to be detected over a time period. Example 27 includes the system of example 26, comprising logic to determine the workload scalability information based at least in part on a number of un-stalled, un-halted cycles of the processor or busyness of a graphics processing unit (GPU) or Graphics Technology (GT). Example 28 includes the system of example 26, wherein the request is to be transmitted from an operating system or a software application. Example 29 includes the system of example 28, further comprising memory to store the operating system or the software application. Example 30 includes the system of example 26, wherein the workload scalability information is to be reevaluated after modification to the request. Example 31 includes the system of example 26, further comprising memory to store the workload scalability information. Example 32 includes the system of example 26, comprising logic to modify one or more of an operating frequency or an operating voltage of the processor in response to the request modification. Example 33 includes the system of example 26, wherein the logic is to modify the request to provide an improved energy efficiency. Example 34 includes the system of example 26, further comprising one or more sensors to detect variations, corresponding to components of the processor, in one or more of: temperature, operating frequency, operating voltage, operating current, dynamic capacitance, power consumption, inter-core communication activity, or the workload scalability information. Example 35 includes the system of example 26, wherein the processor is to comprise one or more processor cores to perform graphics or general-purpose computational operations. Example 36 includes the system of example 26, wherein one or more of the logic, a voltage regulator, or memory are on a single integrated circuit die.

Example 37 includes an apparatus comprising means to perform a method as set forth in any preceding example.

Example 38 includes machine-readable storage including machine-readable instructions, when executed, to implement a method or realize an apparatus as claimed in any preceding claim.

In various embodiments, the operations discussed herein, e.g., with reference to FIGS. 1-13, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-13.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic, the logic at least partially comprising hardware logic, to detect a request to change a performance setting for a processor, wherein the logic is to cause modification to the request based on workload scalability information to be detected by hardware logic in the processor,
wherein the workload scalability information is to be detected over a time period.

2. The apparatus of claim 1, comprising logic to determine the workload scalability information based at least in part on a number of un-stalled, un-halted cycles of the processor or busyness of a graphics processing unit (GPU) or Graphics Technology (GT).

3. The apparatus of claim 1, wherein the request is to be transmitted from an operating system or a software application.

4. The apparatus of claim 3, further comprising memory to store the operating system or the software application.

5. The apparatus of claim 1, wherein the workload scalability information is to be reevaluated after modification to the request.

6. The apparatus of claim 1, further comprising memory to store the workload scalability information.

7. The apparatus of claim 1, comprising logic to modify one or more of an operating frequency or an operating voltage of the processor in response to the request modification.

8. The apparatus of claim 1, wherein the logic is to modify the request to provide an improved energy efficiency.

9. The apparatus of claim 1, further comprising one or more sensors to detect variations, corresponding to components of the processor, in one or more of: temperature, operating frequency, operating voltage, operating current, dynamic capacitance, power consumption, inter-core communication activity, or the workload scalability information.

10. The apparatus of claim 1, wherein the processor is to comprise one or more processor cores to perform graphics or general-purpose computational operations.

11. The apparatus of claim 1, wherein one or more of the logic, a voltage regulator, or memory are on a single integrated circuit die.

12. A method comprising:
detecting a request to change a performance setting for a processor, wherein the logic is to cause modification to the request based on workload scalability information to be detected by hardware logic in the processor,
wherein the workload scalability information is detected over a time period.

13. The method of claim 12, further comprising determining the workload scalability information based at least in part on a number of un-stalled, un-halted cycles of the processor or busyness of a graphics processing unit (GPU) or Graphics Technology (GT).

14. The method of claim 12, further comprising transmitting the request from an operating system or a software application.

15. The method of claim 12, further comprising reevaluating the workload scalability information after modification to the request.

16. A computer-readable medium comprising one or more instructions that when executed on a processor configure the processor to perform one or more operations to:
detect a request to change a performance setting for the processor, wherein the logic is to cause modification to the request based on workload scalability information to be detected by hardware logic in the processor,
wherein the workload scalability information is detected over a time period.

17. The computer-readable medium of claim 16, further comprising one or more instructions that when executed on the processor configure the processor to perform one or more operations to determine the workload scalability information based at least in part on a number of un-stalled, un-halted cycles of the processor or busyness of a graphics processing unit (GPU) or Graphics Technology (GT).

18. The computer-readable medium of claim 16, further comprising one or more instructions that when executed on the processor configure the processor to perform one or more operations to transmit the request from an operating system or a software application.

19. The computer-readable medium of claim 16, further comprising one or more instructions that when executed on the processor configure the processor to perform one or more operations to reevaluate the workload scalability information after modification to the request.

20. The computer-readable medium of claim 16, further comprising one or more instructions that when executed on the processor configure the processor to perform one or more operations to cause modification one or more of an operating frequency or an operating voltage of the processor in response to the request modification.

21. The computer-readable medium of claim 16, further comprising one or more instructions that when executed on the processor configure the processor to perform one or more operations to cause modification of the request to provide an improved energy efficiency.

22. The computer-readable medium of claim 16, further comprising one or more instructions that when executed on the processor configure the processor to perform one or more operations to receive signals from one or more sensors to detect variations, corresponding to components of the processor, in one or more of: temperature, operating frequency, operating voltage, operating current, dynamic capacitance, power consumption, inter-core communication activity, or the workload scalability information.

23. A system comprising:
a processor;
a storage device to store performance settings for the processor; and
logic, the logic at least partially comprising hardware logic, to detect a request to change the stored performance setting for the processor, wherein the logic is to cause modification to the request based on workload scalability information to be detected by hardware logic in the processor,
wherein the workload scalability information is to be detected over a time period.

24. The system of claim 23, comprising logic to determine the workload scalability information based at least in part on a number of un-stalled, un-halted cycles of the processor or busyness of a graphics processing unit (GPU) or Graphics Technology (GT).

25. The system of claim 23, wherein the request is to be transmitted from an operating system or a software application.
